(19) United States
(12) Patent Application Publication
(10) Pub. No.: US 2014/0188657 A1
(43) Pub. Date: Jul. 3, 2014

(54) Establishing Customer Attributes

(71) Applicant: WAL-MART STORES, INC., Bentonville, AR (US)

(72) Inventor: David Patterson, Berkeley, CA (US)

(73) Assignee: Wal-Mart Stores, Inc., Bentonville, AR (US)

(21) Appl. No.: 13/730,449

(22) Filed: Dec. 28, 2012

(51) Int. Cl. G06Q 30/06

(52) U.S. Cl. CPC G06Q 30/0631
USPC 705/26.7

(57) ABSTRACT

The present disclosure extends to methods, systems, and computer program products for establishing a customer's identity via a customer identity server. In operation, customer information is received and evaluated for customer attributes and attribute values. The user is invited to provide information related to the customer's identity that they would like to have established with a merchant. Once a customer identity has been established the methods and systems may provide recommendations based on the customer identity.

### BACKGROUND

Advances in technology have provided convenience for merchants and customers to improve the commerce environment for both online and brick and mortar experiences. Technology has provided the ability for merchants to offer an increasing number of services to an ever increasing number of customers. Merchants can amass large amounts of information about customers during interactions with the customers and this information may be used to influence future transaction opportunities by providing recommendations based on customer identities.

What is needed are methods and systems that are efficient at gathering relevant information about users' attributes, and also effective methods and systems to evaluate this information to form identities and to influence a customer to buy goods and services based on their identity. As will be seen, the disclosure provides methods and systems that can do this in an efficient and elegant manner.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings where:

FIG. 1 illustrates an example block diagram of a computing device;

FIG. 2 illustrates an example retail and computer architecture that facilitates different implementations described herein;

FIG. 3 illustrates a flow chart of an example method according to one implementation;

FIG. 4 illustrates a flow chart of an example method according to one implementation;

FIG. 5 illustrates a flow chart of an example method according to one implementation that accounts for time;

FIG. 6 illustrates a flow chart of an example method according to one implementation that considers changes over time;

FIG. 7 illustrates a flow chart of an example method according to one implementation;

FIG. 8 illustrates a flow chart of an example method according to one implementation;

FIG. 9 illustrates a fragment of a social neighborhood consistent with the discloser;

FIG. 10A illustrates a graphic representation of the strength of the connections in a social neighborhood for use in establishing customer identity; and

FIG. 10B illustrates a graphic representation of the strength of the connections in a social neighborhood for use in establishing customer identity.

### DETAILED DESCRIPTION

The present disclosure extends to methods, systems, and computer program products for determining and customer identities based on user provided information and other related information from the user's activity on social networks. In the following description of the present disclosure, reference is made to the accompanying drawings, which form a part hereof, and in which is shown by way of illustration specific implementations in which the disclosure is may be practiced. It is understood that other implementations may be utilized and structural changes may be made without departing from the scope of the present disclosure.

Implementations of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. RAM can also include solid state drives (SSDs or PCIx based real time memory tiered Storage, such as FusionIO). Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. It should be noted that any of the above mentioned computing devices may be provided by or located within a brick and mortar location. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the disclosure can also be used in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, e.g., on-demand self-service, broad network access, resource pooling, rapid elasticity, measured service, or any suitable characteristic now known to those of ordinary skill in the field, or later discovered), service models (e.g., Software as a Service (SaaS), Platform as a Service (PaaS), Infrastructure as a Service (IaaS), and deployment models (e.g., private cloud, community cloud, public cloud, hybrid cloud, or any suitable service type model now known to those of ordinary skill in the field, or later discovered). Databases and servers described with respect to the present disclosure can be included in a cloud model.

As used herein, the terms “customer” and “user” are used interchangeably, and is intended to denote that a customer can be both contemplated in a brick and mortar retail location as well as a customer who is a user on a computing device, and further, in some instances herein the terms “User” and “You” are used interchangeably as if the reader (referred to as “You”) is hypothetically a customer.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the following description and Claims to refer to particular system components. As one skilled in the art will appreciate, components may be referred to by different names. This document does not intend to distinguish between components that differ in name, but not function.

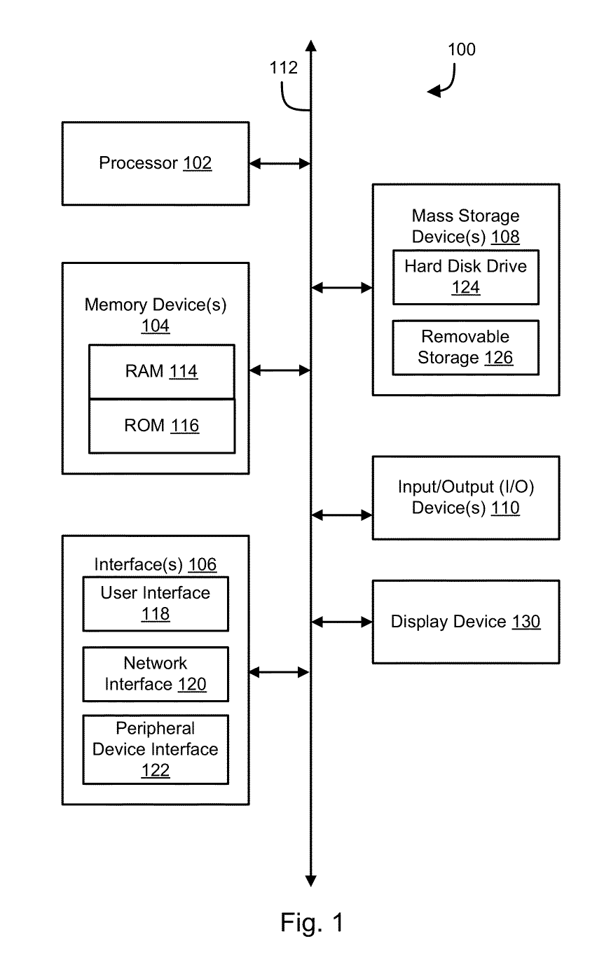

FIG. 1 is a block diagram illustrating an example computing device 100. Computing device 100 may be used to perform various procedures, such as those discussed herein. Computing device 100 can function as a server, a client, or any other computing entity. Computing device can perform various monitoring functions as discussed herein, and can execute one or more application programs, such as the application programs described herein. Computing device 100 can be any of a wide variety of computing devices, such as a desktop computer, a notebook computer, a server computer, a handheld computer, tablet computer and the like.

Computing device 100 includes one or more processor(s) 102, one or more memory device(s) 104, one or more interface(s) 106, one or more mass storage device(s) 108, one or more Input/Output (I/O) device(s) 110, and a display device 130 all of which are coupled to a bus 112. Processor(s) 102 include one or more processors or controllers that execute instructions stored in memory device(s) 104 and/or mass storage device(s) 108. Processor(s) 102 may also include various types of computer-readable media, such as cache memory.

Memory device(s) 104 include various computer-readable media, such as volatile memory (e.g., random access memory (RAM) 114) and/or nonvolatile memory (e.g., read-only memory (ROM) 116). Memory device(s) 104 may also include rewritable ROM, such as Flash memory.

Mass storage device(s) 108 include various computer readable media, such as magnetic tapes, magnetic disks, optical disks, solid-state memory (e.g., Flash memory), and so forth. As shown in FIG. 1, a particular mass storage device is a hard disk drive 124. Various drives may also be included in mass storage device(s) 108 to enable reading from and/or writing to the various computer readable media. Mass storage device(s) 108 include removable media 126 and/or non-removable media.

I/O device(s) 110 include various devices that allow data and/or other information to be input to or retrieved from computing device 100. Example I/O device(s) 110 include cursor control devices, keyboards, keypads, microphones, monitors or other display devices, speakers, printers, network interface cards, modems, lenses, CCDs or other image capture devices, and the like.

Display device 130 includes any type of device capable of displaying information to one or more users of computing device 100. Examples of display device 130 include a monitor, display terminal, video projection device, and the like.

Interface(s) 106 include various interfaces that allow computing device 100 to interact with other systems, devices, or computing environments. Example interface(s) 106 may include any number of different network interfaces 120, such as interfaces to local area networks (LANs), wide area networks (WANs), wireless networks, and the Internet. Other interface(s) include user interface 118 and peripheral device interface 122. The interface(s) 106 may also include one or more user interface elements 118. The interface(s) 106 may also include one or more peripheral interfaces such as interfaces for printers, pointing devices (mice, track pad, etc.), keyboards, and the like.

Bus 112 allows processor(s) 102, memory device(s) 104, interface(s) 106, mass storage device(s) 108, and I/O device(s) 110 to communicate with one another, as well as other devices or components coupled to bus 112. Bus 112 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 100, and are executed by processor(s) 102. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

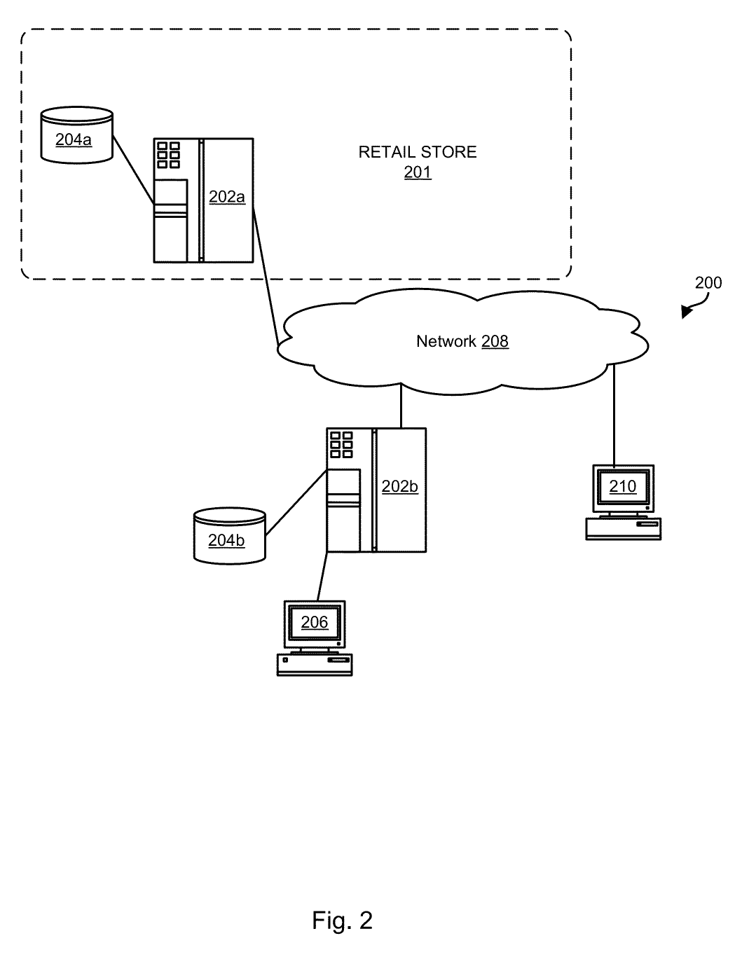

FIG. 2 illustrates an example of a computing environment 200 and a brick and mortar retail location 201 suitable for implementing the methods disclosed herein. In some implementations, a server 202a provides access to a database 204a in data communication therewith and may be located and accessed within a brick and mortar retail location. The database 204a may store customer identity information such as a user profile as well as a list of other user profiles of friends and associates associated with the user profile. The database 204a may additionally store attributes of the user associated with the user profile. The customer/user information hosted by the database 204a may correspond to social media such as Facebook, Twitter, Foursquare, LinkedIn, or the like. The server 202a may provide access to the database 204a to users associated with the user profiles and/or to others. For example, the server 202a may implement a web server for receiving requests for data stored in the database 204a and formatting requested information into web pages. The web server may additionally be operable to receive information and store the information in the database 204a.

A server 202b may be associated with a merchant or by another entity providing gift recommendation services. The server 202b may be in data communication with a database 204b. The database 204b may store information regarding various products. In particular, information for a product may include a name, description, categorization, reviews, comments, price, past transaction data, and the like. The server 202b may analyze this data as well as data retrieved from the database 204a in order to perform methods as described herein. An operator or customer/user may access the server 202b by means of a workstation 206, which may be embodied as any general purpose computer, tablet computer, smart phone, or the like.

The server 202a and server 202b may communicate with one another over a network 208 such as the Internet or some other local area network (LAN), wide area network (WAN), virtual private network (VPN), or other network. A user may access data and functionality provided by the servers 202a, 202b by means of a workstation 210 in data communication with the network 208. The workstation 210 may be embodied as a general purpose computer, tablet computer, smart phone or the like. For example, the workstation 210 may host a web browser for requesting web pages, displaying web pages, and receiving user interaction with web pages, and performing other functionality of a web browser. The workstation 210, workstation 206, servers 202a-202b, and databases 204a, 204b may have some or all of the attributes of the computing device 100.

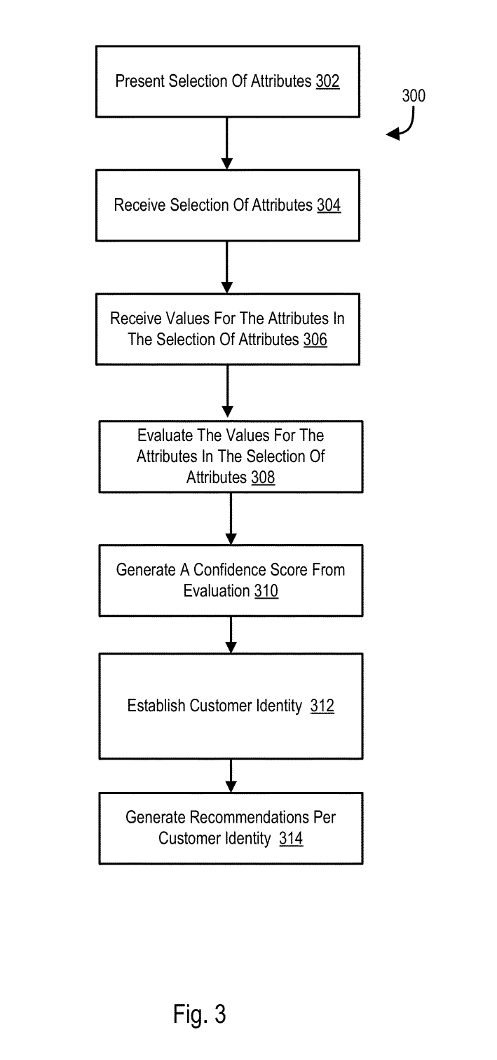

With reference primarily to FIG. 3, an implementation of a method for establishing a customer identity will be discussed. FIG. 1 and FIG. 2 may be referenced secondarily during the discussion in order to provide hardware support for the implementation. The disclosure aims to disclose methods and systems to combine social and traditional sources to allow a customer to establish aspects of customer attributes in order to establish an identity that is suitable for customer-merchant interaction. In other words, a customer identity may be established somewhat equivalent and analogous to that of establishing an identity as a person in a small town, such that services and products can be recommended to the customer as if the customer is personally known when transacting business with the merchant.

Accordingly, the method 300 may include presenting 302 a possible list of selectable attributes that a customer/user may wish to use as part of establishing an identity. In an implementation, establishing a customer identity may be an assembly of digital values and information that represent real world attributes of a customer which are then stored in a digital file that is associated with the customer for merchant use. The list of possible attributes may include such things as: identities, legal documents, images of the customer, utility bills, home address, work history, pay check stubs, car registrations, and/or any other type of attribute information normally used to establish a person's identity. The selection may be made by common computer I/O means such as, example I/O device(s) that may include cursor control devices, keyboards, keypads, microphones, monitors or other display devices, speakers, printers, network interface cards, modems, lenses, CCDs or other image capture devices, and the like. At 304 the selection made by a customer for the attribute categories they wish to present may be received into a system and stored in memory. At 304, the received information from a customer may be digital in the form and may comprise digital copies of: State issued ids, legal documents, images of the customer, utility bills, home address, work history, pay check stubs, car registrations, and/or any other type of attribute information normally used to establish a person's identity. Additionally, a customer/user at a computer terminal may be able to enter attribute data in order to fill-in fields that represent the selection of attributes. The information provided, either digitally or in the retail location, may then be evaluated 308 for content and applicability. Various methods of evaluation 308 may be performed and will be discussed in greater detail below with regard to non-limiting examples. The method may then generate 310 a confidence score that may be correlated to the quality and nature of the evaluated 308 attribute values. With the attribute data and associated confidence score stored on the customer identity server, an identity for a customer can be established 312 and stored on the customer identity server for use on behalf of the customer for generating 314 recommendations to the customer for products and services offered by the merchant. For a non-limiting example, a driver's license may be selected 304 by a customer, and received from the customer as one of the selected attributes for establishing the customer's identity with the merchant at a retail location. A representative for the merchant may evaluate 308 the driver's license and make a digital copy for storage on a customer identity server for later use on behalf of the customer. The evaluation by the representative may be to authenticate the driver's license as real, not expired, and/or perform any other typical evaluation for a driver's license. In the present example, the representative may then generate 310 a confidence score for the driver's license and enter the confidence score into the memory of the customer identity server for use in establishing 312 a customer identity. The customer identity comprising the driver's license information and confidence score may then be used to generate recommendations 314 for the customer.

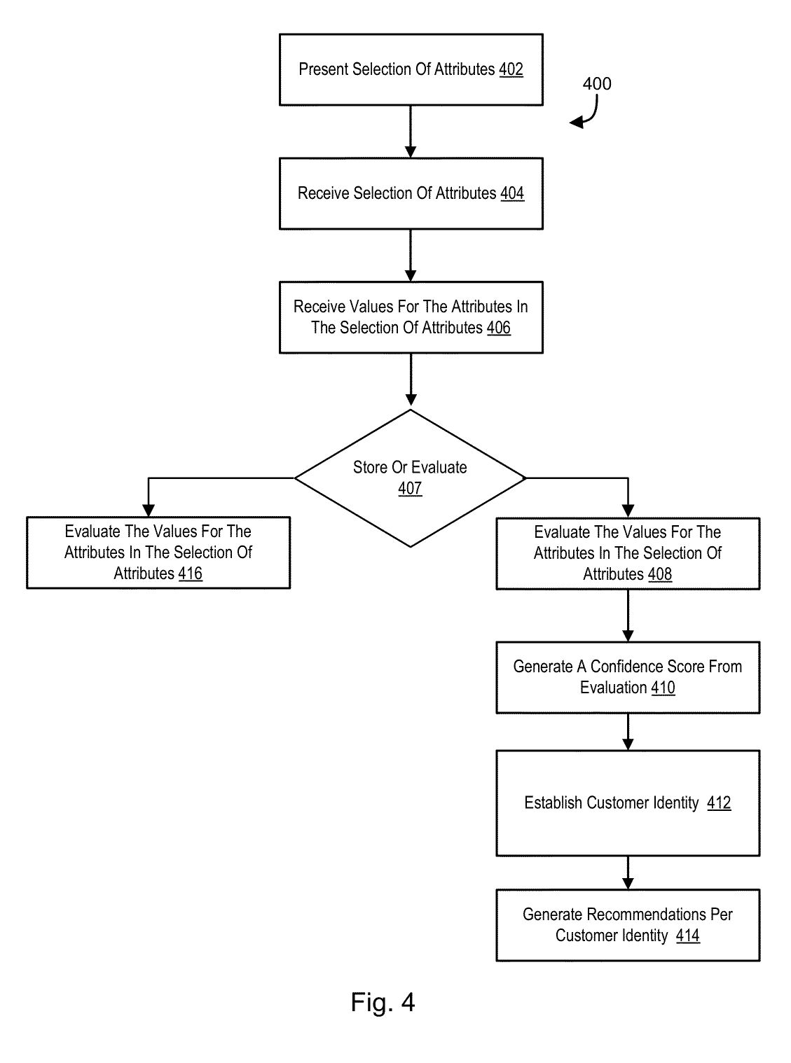

With reference primarily to FIG. 4, an implementation of a method for establishing customer identity with the additional feature of the customer attribute data being stored for later use or to be evaluated as discussed above. It is a feature and aspect of the present disclosure to provide a level of comfort to a customer by not encroaching, or seeming to encroach, the customer's privacy level. Accordingly, a method 400 may provide the customer with the option to store or evaluate 407 the attributes values and data. In use, the method 400 may include presenting 402 a possible list of selectable attributes that customer/user may wish to use as part of establishing an identity. At 404 the selection made by a customer for the attribute categories they wish to provide may be received into a system and stored in memory. At 404, the received information from a customer may be digital in form and may comprise digital copies of such things as: State issued ids, legal documents, images of the customer, utility bills, home address, work history, pay check stubs, car registrations, and/or any other type of attribute information normally used to establish a person's identity. Additionally, a customer/user at a computer terminal may be able to enter attribute data in order to fill-in fields that represent the selection of attributes. The information provided, either digitally or in the retail location, may then be evaluated 408 for content and applicability. Various methods of evaluation 408 may be performed and will be discussed in greater detail below by way of non-limiting examples. The method may then generate 410 a confidence score that may be correlated to the quality and nature of the evaluated 408 attribute values. With the attribute data and associated confidence score stored on the customer identity server, an identity for a customer may be established 412 and stored on the customer identity server for use on behalf of the customer for generating 414 recommendations to the customer for products and services offered by the merchant. For a non-limiting example, a utility bill may be selected 404 by a customer to provide attributes, and a digital copy may be received from the customer over a network. The customer may then be presented with an option 407 of having the utility bill and associated attributes evaluated or merely stored on the customer identity server for later use. As discussed above, giving a customer/user the option against having the provided utility bill evaluated may provide the customer with comfort, and may allow the customer the ability to present multiple items before being evaluated in order to establish a more detailed identity. It is to be understood that it is within the scope of this disclosure to allow a user to select both storage and evaluation in an implementation of the methods. A computer and/or server may evaluate 408 the utility bill for storage on a customer identity server for later use on behalf of the customer. The evaluation by the representative may be to authenticate the utility bill as real, and/or gather information from the utility bill such as name, address, usage, length of time for billing relationship, and other like information. In the present example, the system may then generate 410 a confidence score for the utility bill based on the evaluation, and then enter the confidence score into the memory of the customer identity server for use in establishing 412 a customer identity. The customer identity comprising the utility bill information and confidence score may then be used to generate recommendations 414 for the customer.

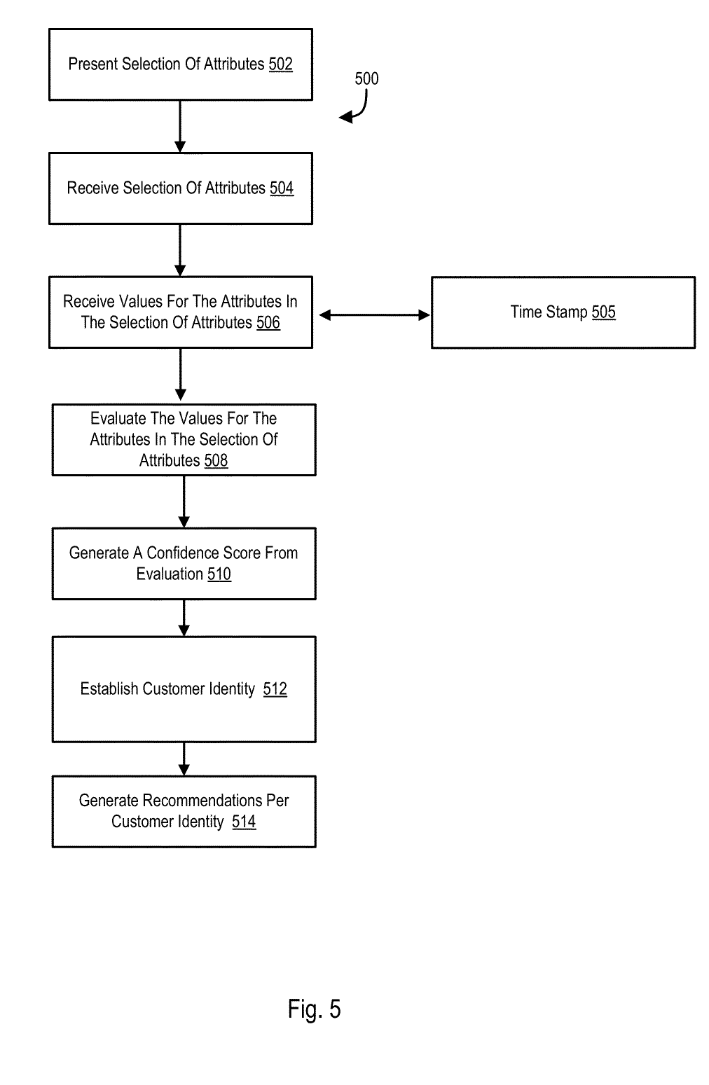

With reference primarily to FIG. 5, an implementation of a method for establishing customer identity wherein time data is recorded as the customer provides and a system receives additional attribute information. It is a feature and aspect of the present disclosure to provide the ability for a merchant to associate a time stamp with information provided by a customer. Accordingly, a method 500 may provide the feature of tracking the time (via a time stamp 505) at which a customer offers additional information. In use, the method 500 may include presenting 502 a possible list of selectable attributes that a customer/user may wish to use as part of establishing an identity. At 504 the selection made by a customer for the attribute categories they wish to present may be received 504 into a system and stored in memory. At 506, the received information from a customer may be digital in form and may comprise digital copies of such things as: State issued ids, legal documents, images of the customer, utility bills, home address, work history, pay check stubs, car registrations, and/or any other type of attribute information normally used to establish a person's identity. Additionally, a customer/user at a computer terminal may be able to enter attribute data in order to fill-in fields that represent the selection of attributes. At 505, the attribute data received into the system may be time stamped in order to provide the additional information about when a customer has entered attribute data. Time stamp data can be used to provide timeliness information about a customer for such uses as, for example, providing timely recommendations for seasonal items and services. The information provided, either digitally or in the retail location, may then be evaluated 508 for content and applicability. The method may then generate 510 a confidence score that may be correlated to the quality and nature of the evaluated 508 attribute information. With the attribute data and associated confidence score stored on the customer identity server, an identity for a customer can be established 512 and stored on the customer identity server for use on behalf of the customer for generating 514 recommendations to the customer for products and services offered by the merchant. For a non-limiting example, a legal document regarding the purchase of a home may be selected 504 by a customer to provide attributes, and a digital copy may be received from the customer over a network and may be time stamped 505 with an associated time of receiving by the merchant. A computer and/or server may evaluate 508 the legal document for storage on a customer identity server for later use on behalf of the customer. An evaluation by the representative or system may be to authenticate the legal document as real, and/or may gather information from the legal document such as name, address, size, yard type, existence of a pool, and other like information. In the present example, the system may then generate 510 a confidence score for the legal document based on the evaluation, and then enter the confidence score into the memory of the customer identity server for use in establishing 512 a customer identity. The customer identity comprising the legal document information, time stamp and confidence score may then be used to generate recommendations 514 for the customer.

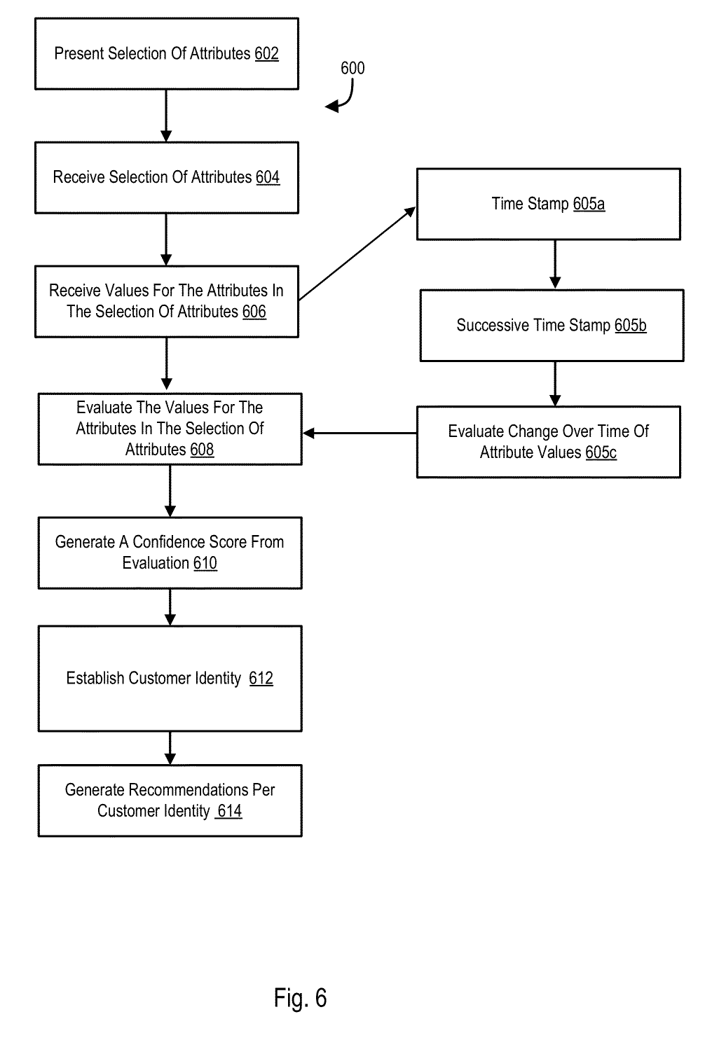

With reference primarily to FIG. 6, an implementation of a method for establishing customer identity wherein attribute change over time is evaluated as a system receives additional or subsequent customer identity information. It is a feature and aspect of the present disclosure to provide the ability for a merchant to track how customer attributes may change over time. Accordingly, a method 600 may provide the feature of tracking change over time, by comparing attribute information received into the system at a time stamp 605a to additional attribute information received into the system at a subsequent time stamp 605b. In use, the method 600 may include presenting 602 a possible list of selectable attributes that a customer/user may wish to use as part of establishing an identity. At 604 the selection made by a customer for the attribute categories they wish to present may be received 604 into a system and stored in memory. At 606, the received information from a customer may be digital in form and may comprise digital copies of such things as: State issued ids, legal documents, images of the customer, utility bills, home address, work history, pay check stubs, car registrations, and/or any other type of attribute information normally used to establish a person's identity. Additionally, a customer/user at a computer terminal may be able to enter attribute data in order to fill-in fields that represent the selection of attributes. At 605a, the attribute data received into the system may be time stamped in order to provide the additional information about when a customer has entered attribute data. Time stamp data can be used to provide timeliness information about a customer for such uses as, for example, providing timely recommendations for seasonal items and services. At 605b, subsequent time stamp data may be associated with additional attribute information received by the system. At 605c, the attribute change between the time stamp of 605a and 605b is evaluated and recorded on to the customer identity server. The information provided by a customer and the attribute change data provided at 605c may then be evaluated 608 for content and applicability. The method may then generate 610 a confidence score that may be correlated to the quality and nature of the evaluated 608 attribute information. With the attribute data and associated confidence score stored on the customer identity server, an identity for a customer can be established 612 and stored on the customer identity server for use on behalf of the customer for generating 614 recommendations to the customer for products and services offered by the merchant. For a non-limiting example, a legal document regarding the purchase of a home may be selected 604 by a customer to provide attributes, and a digital copy may be received from the customer over a network and may be time stamped 605a with an associated time of receiving by the merchant. A computer and/or server may evaluate 608 the legal document for storage on a customer identity server for later use on behalf of the customer. An evaluation by the representative or system may be to authenticate the legal document as real, and/or may gather information from the legal document such as name, address, size, yard type, existence of a pool, and other like information. In the present example, the customer may provide a second legal document regarding the sale of the home and the purchase of another home. The second legal document may receive a subsequent time stamp 605b. An evaluation of the second legal document may then be performed by the representative or system may be to authenticate the legal document as real, and/or may gather information from the legal document such as name, address, size, yard type, existence of a pool, and other like, of the second home. An evaluation of change over time 605c may then be performed comparing the attributes of the first home with the attributes of the second home. The system may then generate 610 a confidence score for the legal documents based on the evaluations, and then enter confidence scores into the memory of the customer identity server for use in establishing 612 a customer identity. The customer identity comprising the legal documents information, change over time information and confidence scores may then be used to generate recommendations 614 for the customer.

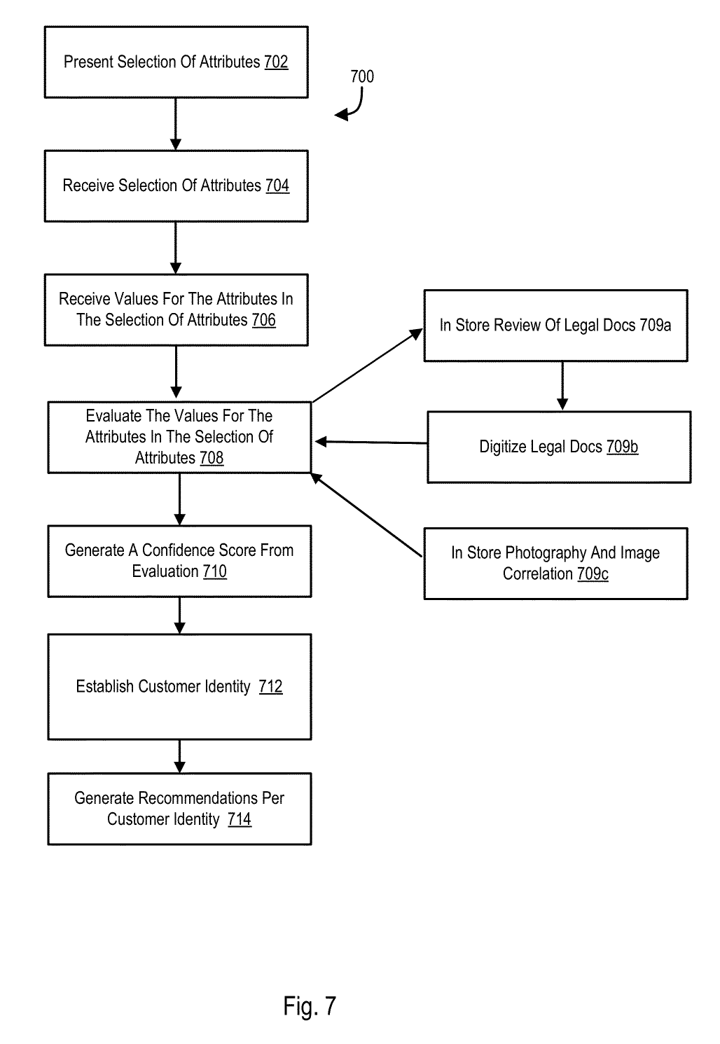

With reference primarily to FIG. 7, an implementation of a method for establishing customer identity wherein a customer enters a retail location of a merchant. It is a feature and aspect of the present disclosure to provide the ability for a merchant to offer various in-person or in-store experiences to establish a customer identity. Accordingly, a method 700 may provide the feature of providing services such as legal documents review and notarization 709a, photo services 709c and passport services, digitizing services for electronic storage 709b, and financial services, and any other service and product typically provided by a merchant. In use, the method 700 may include presenting 702 a possible list of selectable attributes that a customer/user may wish to use as part of establishing an identity. At 704 the selection made by a customer for the attribute categories they wish to present may be received 704 into a system and stored in memory. At 706, the received information from a customer may be digital in form and may comprise digital copies 709b of such things as: State issued ids, legal documents, images of the customer, utility bills, home address, work history, pay check stubs, car registrations, and/or any other type of attribute information normally used to establish a person's identity. Additionally, a customer/user at a computer terminal may be able to enter attribute data in order to fill-in fields that represent the selection of attributes. The attribute data received into the system may be time stamped in order to provide the additional information about when a customer has entered attribute data. The information provided by a customer may then be evaluated 708 for content and applicability. In an implementation a system may evaluate legal documents by an in-store review 709a by an associate. In the present implementation, the associate may digitize 709b, the documents for storage and attribute data gathering. Additionally, an implementation may comprise acquiring a customer's image through photo services 709c, wherein the images are used for image correlation for establishing customer identity with an associated image. The method may then generate 710 a confidence score that may be correlated to the quality and nature of the evaluated 708 attribute information and other attribute data gathered in steps 709a, 709b and 709c. With the attribute data and associated confidence score stored on the customer identity server, an identity for a customer can be established 712 and stored on the customer identity server for use on behalf of the customer for generating 714 recommendations to the customer for products and services offered by the merchant.

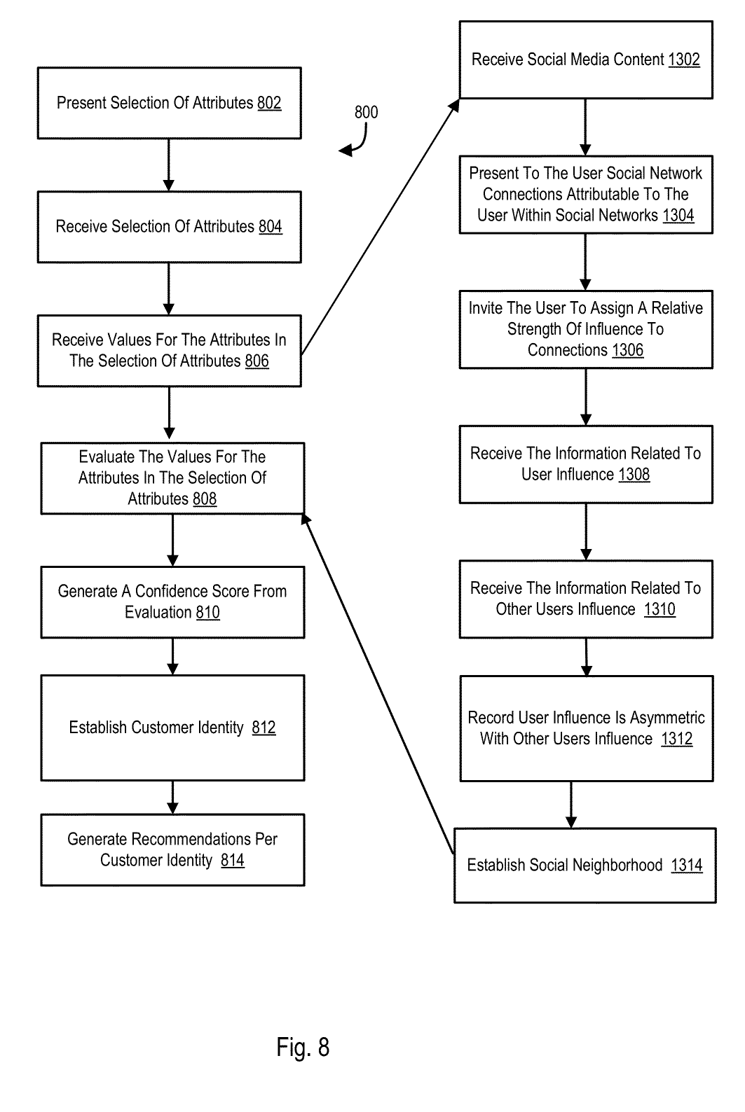

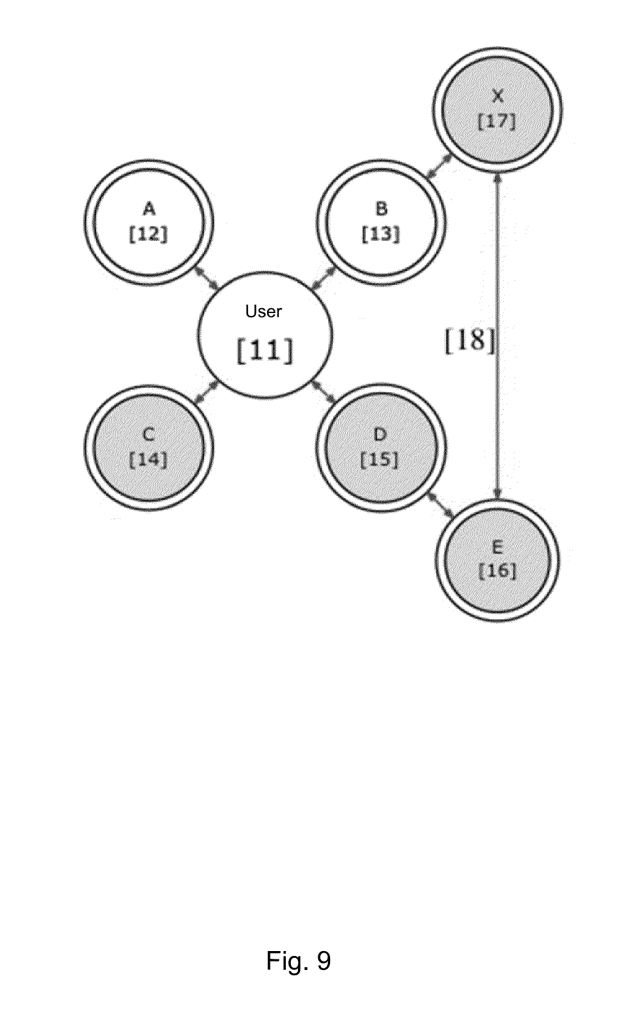

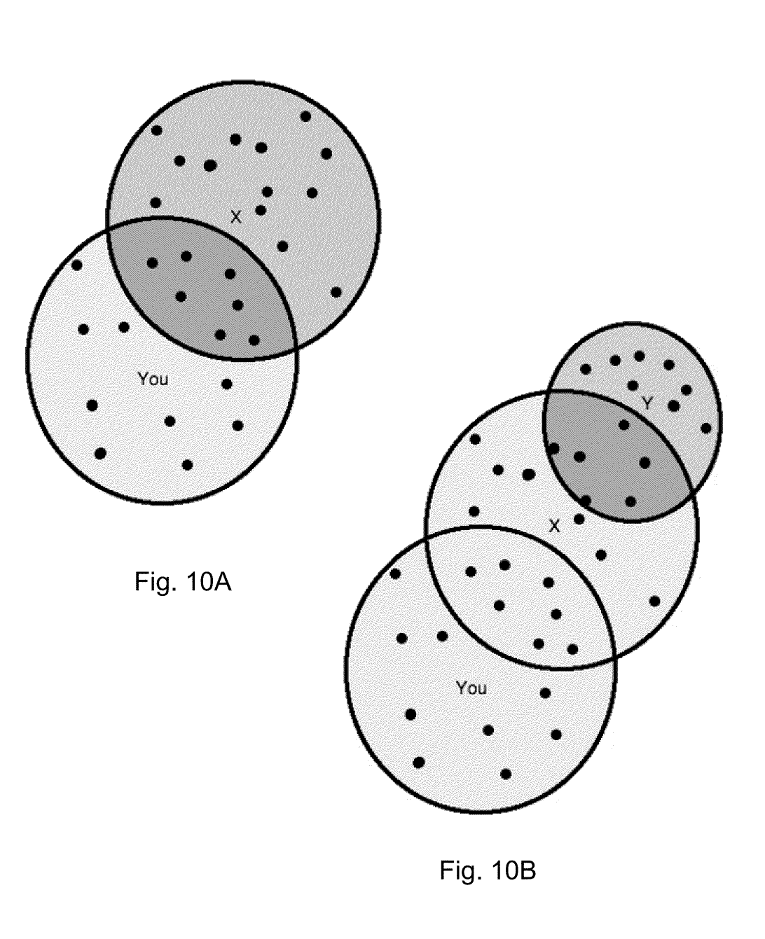

With reference primarily to FIG. 8, an implementation of a method for establishing customer identity wherein a customer's social networks may contribute to the attribute information that is gathered. It is a feature and aspect of the present disclosure to provide the ability for a merchant to establish a customer's identity through the customer's social connects on social networks and association with other in-store customers. Accordingly, a method 800 may provide the feature of receiving customer social network information from a social network. In use, the method 800 may include presenting 802 a possible list of selectable attributes that a customer/user may wish to use as part of establishing an identity. At 804 the selection made by a customer for the attribute categories they wish to present may be received 806 into a system and stored in memory. At 806, the received information from a customer may be digital in form and may comprise receiving social network content 1302 for the customer. The social media content may include any type of behavior or actions made by a user, or other users within a social media site. Behavior and actions that may be of value in defining social neighborhoods for the customer may be, for example: connections to other users, posts in the form of texts, preferences shown by likes or dislikes, connections to non-directly connected other users (friends of friends), product commentary by various users, places visited as shown by checking in functionality within the various social media sites. FIGS. 9, 10A, and 10B, discussed in detail below, further illustrate customer/user connection is a social network. The above mentioned examples are not intended to be limiting, and it is intended that any data generated by socially relevant sites is included within the scope of this disclosure. In an implementation, a user (or “You,” if the reader hypothetically might be a customer) may be able to designate which social media sites that may be desirable to obtain information from, or the sites may be automatically selected by the method. At 1304, the social media content may be presented to a user for assessment by the user. For example, a user may be presented with a list of all of her social connections from her social media sites. In such an example the user may wish to select all of the available connections, or may wish to limit the selection to only a certain number of connections. The selection process by the user may be accomplished through any commonly known means such as, for example, mouse clicks, keyboarding, touch screen etc., through a user interface on the user's computer The selection may then be stored in computer readable memory for use by the method 800.

At 1306, a user may be asked to assign a strength of influence for each of the connections received from the social networks (“strength of influence” will sometimes be referred to as “distance”). The assigning process by the user may be accomplished through any commonly known means such as, for example, mouse clicks, keyboarding, touch screen etc., through a user interface on the user's computer. The strength of influence assignments may then be stored in computer readable memory for use by the method 800. In an implementation, the method 800 will receive user influence 1308 information (data) by asking the user to assign a strength of influence for a connection that represents the user's influence over an other user. Likewise, the method 800 will receive user influence 1310 information (data) by asking the user to assign a strength of influence for a connection that represents the influence that an other user may have over the user herself. At 1312 the strength of influence information may be recorded into memory as an influence metric. Influence metrics may be discussed in the terms of distance, even though an actual distance may not exist between the points of social data used in the method. In other words the terms “social distance” and “distance” as used herein, is more figurative than actual.

At 1314, a list of recommendations may be created for the user base on his social neighborhood and the behavior of others within the social neighborhood. For example, if influential users of the neighborhood are purchasing and talking about certain goods, it is likely that the user may desire to purchase those same goods. As such, a timely recommendation from a commonly used retailer of goods would prove beneficial to both the retailer and the user. The attribute data received into the system may be time stamped in order to provide the additional information about when a customer has entered attribute data. The information provided by a customer may then be evaluated 808 for content and applicability. In an implementation a system may evaluate the social network attribute data, or another customer may be able to vouch for the customer within a retail location. The method may then generate 810 a confidence score that may be correlated to the quality and nature of the evaluated 808 attribute information and the other social attribute data gathered in steps 1302 through 1312. With the attribute data and associated confidence score stored on the customer identity server, an identity for a customer can be established 812 and stored on the customer identity server for use on behalf of the customer for generating 814 recommendations to the customer for products and services offered by the merchant.

FIG. 9 illustrates a fragment of an overall social network, in which a user (“User” [11]) belongs to two separate social networks, with other users from one network indicated by white filled circles (namely users “A”[12], “B”[13]”) and users from another social network indicated by grey filled circles (namely “C”[14], “D”[15], “E”[16] and “X”[17]. In our disclosure, the two social networks are joined into a single overall network. The figure indicates which users are directly connected, i.e. who know each other as indicated in the social network, by arrowed lines. An other user X is, like the User, is a user of both social networks and has a connection to E in one and to B in the other. In this example, if each connection represents the same distance or strength between nodes (a node represents a user or an organization in the network), the shortest path from the User to X is the user to B to X, which may be indicated in terms of distance for the strength of influence value in the metric. The influence values may be converted to distances by a transformation that may be approximately equal to −log 10(S/10+0.01), where the term in parentheses is used as an estimate of the probability of a message being transmitted across the connection.

A user of the disclosure can explore his meta-network in a number of ways, without limitation to a small number of connections that may link him to another user. Among the interactive exploration methods, a user can modify this network, such as shown in FIG. 9, by removing nodes to find alternate paths of connection to another user. In an implementation, a user may further specify the influence values, and thereby modify the social network distances, to other nodes, in separate contexts such as one for work, one for recreation, and so on, leading to a separate analysis of the social network for each different context.

FIG. 10A and FIG. 10B illustrate schematics of a social network in which the network's shortest-path connections between user (or “You,” if hypothetically the reader were a user) and other users (represented by dots) are not shown, but the distances of dots from user (or “You”) is proportional to the shortest path distance from user to the other user. This is a key element of our disclosure, namely that important analysis of the social network is performed on the (non-geometric) distance matrix without further regard for the underlying network connections themselves to yield a set of “neighbors” for each user. The relationship of another user, X, is introduced with the same construction. Circles indicate the “neighborhood radius” for user and X that is considered to be the limit of meaningful connection. The area of overlap, containing users within the influence neighborhood radius of both user and other user X, is a measure of the influence between user and X.

FIG. 10A further shows a step in clustering, based on the neighbors of users, to indicate how the cluster consisting of both User (or “You”) and X may overlap with an influence neighborhood of user Y to form an additional cluster of all three users plus those users within the neighborhood radius of any of the three. In this step, it is clear that some users of the influence neighborhood associated with User (or “You”) are rather distant from some users of the influence neighborhood of user Y. Nevertheless, they share a large influence cluster. This figure represents a valuable aspect of the disclosure. In particular, we see that the influence group of a user may be influenced by users not closely connected in the social network. (It can be shown mathematically that all users in such clusters are connected by one or more paths in the underlying network.)

In an implementation, the method and system may replace the hierarchical clustering based on influence neighborhoods with fuzzy cluster analysis, or replacing the idea of a neighborhood radius to place users inside or outside the influence neighborhood with a fuzzy membership that is high at small distances and effectively zero at larger distances. The representation of such influence groups can be made graphically, as has been done with clusters of chemicals (see for example Clark et al, “Visualizing substructural fingerprints”, J. Mol. Graph. Model. 2000, vol 18 pp 404-411).

In an implementation, the operation of the disclosed methods and systems provide useful neighborhood determinations by: First, a context is selected that defines the specific social network involved (work related, social, etc.); Second, a neighborhood distance is selected such that for each user any other user within that distance is considered an influence neighbor of the user. As used herein, distances may be the shortest path distances, with direct connection distances defined by the scores S, and connected paths with intervening nodes assigned distances that are the sum of the (direction dependent) distances of the individual directly connected edges (an edge represents a known direct connection between two nodes or users).

For each user, the set of other users within a distance (or strength of influence) N is obtained and stored for efficient processing. In an implementation, the form is that of a run-length-encoded compression of a bitset; the bitset contains a 1 for every user who is an influence neighbor and a 0 for every other person. The bitset has as many bits as there are people in the network. Since no user knows more than half of all people, the bitsets may be sparse, consisting mostly of 0 bits.

These bitsets, one for each user in the network, represent separate clusters. There may be substantial overlap among users in the users to whom they are connected (equivalently, to the bits set to “1” in their bitsets). The bitsets maybe affected by the asymmetry of the connection distances: user A may include user B in his neighborhood while user B may not include user A in her neighborhood if she has specified a high distance to user A. The similarity between any pair of users can be evaluated by this overlap. In an implementation the measure of such overlap may be: the number of shared users measured as the number of bits set to “1” in the intersection of their bitsets, when the overall network is sparse and such intersections are few, or the Tanimoto measure of similarity, which is measured as the number of “1” bits in the intersection of the two bitsets divided by the number of “1” bits in the intersection of the two bitsets. The Tanimoto index may be used and measures the fraction of overlap rather than the absolute count of overlap.

Bitsets may be then joined in a hierarchical fashion, such that:

the two clusters with highest similarity may be joined at each step;

The two clusters are then converted to a single cluster, as in FIG. 10A and FIG. 10B, and their bitsets may be set to the union of their separate bitsets.

This joining operation may continue until the similarities drop below a specified value, or until there is no overlap between the remaining clusters. In the latter case, the remaining clusters are effectively disjointed subnetworks in the sense that no user of any such cluster is within the neighborhood radius of any user of any other such cluster. Therefore, the clustering thus derived is relatively insensitive to small changes in the underlying network and to small changes in the distance of directly connected nodes. It further represents a multi-tiered description of the overall social network which can be approximated with traditional sampling techniques of the individual user's bitsets if the size of the network becomes larger than is practical (note that analysis of the network in the direct sense is very sensitive to subsampling and to missing information, while subsampling of the full bites descriptions is not so.)

In an implementation where users are unable to provide full information about their networks, unique identifier codes of the nodes of a user's network may be stored with in a system, which assures that our disclosure can immediately associate a new user with her connections that are already users within our disclosure's implementation. For example, user A may provide the unique identifier codes of all his connections within one social network, which includes a code XXXXX that refers to an unknown user. If another user has linked to the same code XXXXX, the system may shows that the two users are linked to a same user (unknown but known to the users). At any point when the user with code XXXXX joins as a user of our disclosure, the identity becomes known to us and can be shared with our users. If user with code XXXXX is a user of an additional social network in which he has code YYYYY, then the association is made between the two social networks, and our meta-network can connect two users whose connection spans the two separate social networks, as in FIG. 9.

Thus the disclosure provides a method and system for establishing a customer identity by evaluating the structure of a social, which is robust to small changes within the social network, and which reveals important aspects of the influence among users of the network that are not easily identified by currently existing means.

The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

1. A method for establishing a customer identity of a user, comprising:
presenting to the user a group of selectable attributes for establishing a customer identity;
receiving a selection of attributes made by the user;
receiving values for the attributes in the selection of attributes from the user;
presenting to a user a selectable option for evaluating the values for the selection of attributes for establishing the customer identity or for storing the values on a customer identity server;
evaluating the values for the selection of attributes;
providing a confidence score corresponding to the values for the selection of attributes;
creating a customer identity comprising the confidence score; and
generating recommendations based on the user's customer identity and corresponding confidence score.

2. A method according to claim 1, wherein recording in memory a time stamp corresponding to the selection of attributes and values for the selection of attributes;

3. A method according to claim 2, further comprising the customer identity is updated by evaluating values for the selection of attributes associated with subsequent receiving information from a user regarding values for the selection of attributes corresponding to a subsequent time stamp.

4. A method according to claim 1, further comprising receiving information from a verifying entity regarding a user's attributes for assisting establishing the customer identity.

5. A method according to claim 4, wherein said verifying entity is a utility company.

6. A method according to claim 1, wherein the evaluation of the values for the selection of attributes is an in-store examination of the values by an representative of a store and wherein said values for the selection of attributes comprise: a drivers license, a government issued id, legal document, utility bill, and bank statements.

7. A method according to claim 1, wherein the evaluation of the values for the selection of attributes is performed by an in-store notary public notarizing documents and visually confirming information of which digital copies will be stored on the customer identity server.

8. A method according to claim 1, wherein the evaluation of the values for the selection of attributes is person to person recognition based on images of the customer by in-store photography.

9. A method according to claim 1, wherein the evaluation of the values for the selection of attributes is a verification provided by other customers.

10. A method according to claim 1, wherein the evaluation of the values for the selection of attributes is verified by comparing customer attributes received from social networks.

11. A system for establishing a customer identity of a user, comprising:
a retail location;
one or more processors and one or more memory devices operably coupled to the one or more processors and storing executable and operational data, the executable and operational data effective to cause the one or more processors to:
present to the user a group of selectable attributes for establishing a customer identity;
receive a selection of attributes made by the user;
receive values for the attributes in the selection of attributes from the user;
present to a user a selectable option for evaluating the values for the selection of attributes for establishing the customer identity or for storing the values on a customer identity server;
evaluate the values for the selection of attributes;
provide a confidence score corresponding to the values for the selection of attributes;
establish a customer identity comprising the confidence score; and
generate recommendations based on the user's customer identity and corresponding confidence score.

12. A system according to claim 11, further comprising recording in memory a time stamp corresponding to the selection of attributes and values for the selection of attributes;

13. A system according to claim 12, further comprising the customer identity is updated by evaluating values for the selection of attributes associated with subsequent receiving information from a user regarding values for the selection of attributes corresponding to a subsequent time stamp.

14. A system according to claim 11, further comprising receiving information from a verifying entity regarding a user's attributes for assisting establishing the customer identity.

15. A system according to claim 14, wherein said verifying entity is a utility company.

16. A system according to claim 11, wherein the evaluation of the values for the selection of attributes is an in-store examination of the values by an representative of a store and wherein said values for the selection of attributes comprise: a drivers license, a government issued id, legal document, utility bill, and bank statements.

17. A system according to claim 11, wherein the evaluation of the values for the selection of attributes is performed by an in-store notary public notarizing documents and visually confirming information of which digital copies will be stored on the customer identity server.

18. A system according to claim 11, wherein the evaluation of the values for the selection of attributes is person to person recognition based on images of the customer by in-store photography.

19. A system according to claim 11, wherein the evaluation of the values for the selection of attributes is a verification provided by other customers.

20. A system according to claim 11, wherein the evaluation of the values for the selection of attributes is verified by comparing customer attributes received from social networks.
